(19) United States
(12) Patent Application Publication
(10) Pub. No.: US 2023/0389737 A1
(43) Pub. Date: Dec. 7, 2023

(54) METHODS AND APPARATUS FOR SANITARY AND CONVENIENT FEEDING

(71) Applicant: Papeltec Overseas, Inc., Atlantic Beach, FL (US)

(72) Inventor: Victor Rodriguez, Jacksonville, FL (US)

(73) Assignee: Papeltec Overseas, Inc., Atlantic Beach, FL (US)

(21) Appl. No.: 18/204,803

(22) Filed: Jun. 1, 2023

Related U.S. Application Data
(60) Provisional application No. 63/394,364, filed on Aug. 2, 2022.
(60) Provisional application No. 63/349,823, filed on Jun. 7, 2022.

(51) Int. Cl. A47G 21/04; B65D 83/00; B65D 47/12

(52) U.S. Cl. CPC A47G 21/04; B65D 83/0055; B65D 47/122; B65D 83/0022

(57) ABSTRACT

An apparatus for feeding a person viscous food includes a food container including a food storage portion containing viscous food and a first connector on an open end of the food storage portion. The food storage portion being compressible. A feeding device includes a feeding surface and a second connector removably attachable to the first connector. A method for feeding the person includes removably connecting a food container containing viscous food to a feeding device and expelling an amount of the viscous food from the food container. At least a portion of the amount of expelled viscous food flows onto a feeding surface of the feeding device. The method further includes providing the portion of the viscous food on the feeding surface of the feeding device to the person.

### CROSS-REFERENCE TO RELATED APPLICATIONS

This application claims priority to and the benefit of U.S. Provisional Patent Application No. 63/349,823 filed on Jun. 7, 2022, and U.S. Provisional Patent Application No. 63/394,364 filed on Aug. 2, 2022, the contents of each of which are incorporated by reference in their entireties into the subject matter of the present application.

### FIELD OF THE DISCLOSURE

The present disclosure relates to methods and apparatus to support convenient and hygienic feeding of a young child (or physically inhibited adult) that is capable of ingesting viscous food. The apparatus may include designs of food containers and connection apparatus for holding a feeding device such as a modified spoon.

### BACKGROUND OF THE DISCLOSURE

Modern families are much more mobile than traditional family units that often enjoyed regular and consistent mealtimes and at home meals. Families are now forced to take meals on the go as they are able, and in places that are not conducive to traditional family meals. Just as the shift to an industrial society created a need for prepared foods such as cereal (currently one of the largest volume food types), there is now a need for portable viscous foods that may be hygienically stored, carried, dispensed, and fed to a young person that is at stage of development where they can ingest viscous foods as an addition or alternative to formula (or mother's milk).

### SUMMARY OF THE DISCLOSURE

Accordingly, the present disclosure provides methods and apparatus for feeding a person incapable of feeding themselves, the method including the steps of connecting a food pouch or other food container containing viscous food in an interior of the food container to a spoon or other receiving device suitable for feeding. The feeding device may include a feeding surface exterior to the food pouch. A compressive force may be applied to the exterior surface of the food pouch (or other food containing receptacle) to expel the viscous food out of the food pouch onto the feeding surface.

Examples may also include disconnecting the food pouch from the feeding device and closing a one-way valve thereby sealing the viscous food interior to the food pouch from contaminants exterior to the food pouch. Preferably a cap may also be placed on the one-way valve.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure:

FIG. 1 illustrates exemplary components that may be included in some embodiments of the present invention.

FIG. 2 illustrates, in a disassembled state, exemplary components that may be included in some embodiments of the present invention.

FIG. 3 illustrates exemplary alternative embodiments that use a syringe type apparatus as a food container.

FIG. 4 illustrates an exemplary hygienic food containment area for sealing contaminants away from the food storage area and exemplary valves that may be included.

FIGS. 4A and 4B illustrate an exemplary valves that may be included to contain food in a food storage area.

FIG. 5 illustrates exemplary embodiments with interchangeable different sized feed devices that may be used to feed persons of different sizes, such as young children and adults.

FIG. 6 illustrates a flowchart of exemplary method steps that may be executed in some implementations of the present invention.

FIG. 7 illustrates a perspective view and a cutaway view of a feeding device according to some embodiments of the present invention.

### DETAILED DESCRIPTION

The present disclosure provides generally for apparatus and methods for feeding a young or physically inhibited person by dispensing viscous food directly from a food container onto a feeding device including a spoon or other feeding surface. The viscous food container may be removably attached to the feeding device such that during a meal the feeding device remains attached to the food container and following the meal, the spoon may be detached from the container and the food container may be sealed.

In preferred embodiments, the viscous food passes through at least one one-way valve that only permits the viscous food to pass in a single direction of travel and prevents contaminants from entering into the food container. Still further, some embodiments may include multiple one-way valves that use a small quantity of viscous food dispensed between the multiple valves to act as a seal and further prevent contaminants from entering the food container.

Embodiments of the present disclosure may include a method of feeding a person incapable of feeding themselves, the method including the steps of connecting a food container containing viscous food in an interior of the food container to the feeding device including the feeding surface exterior to the food container. Embodiments may also include applying compressive force to an exterior surface of the food container.

Embodiments may also include using the compressive force to expel an amount of the viscous food from the interior of the food container through a one-way valve to an exit path from the food container. At least some of the expelled viscous food will be caused to flow onto the feeding surface of the feeding device. The viscous food on the feeding surface may then be fed to the person for consumption. Following a meal provided during a feeding session, the food container may be disconnected from the feeding device and the food remaining in the food container can be sealed in the food container with a cap.

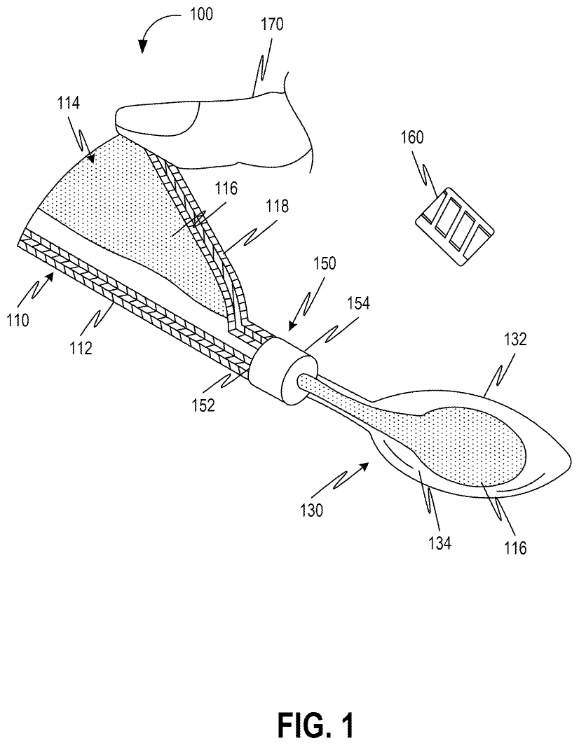

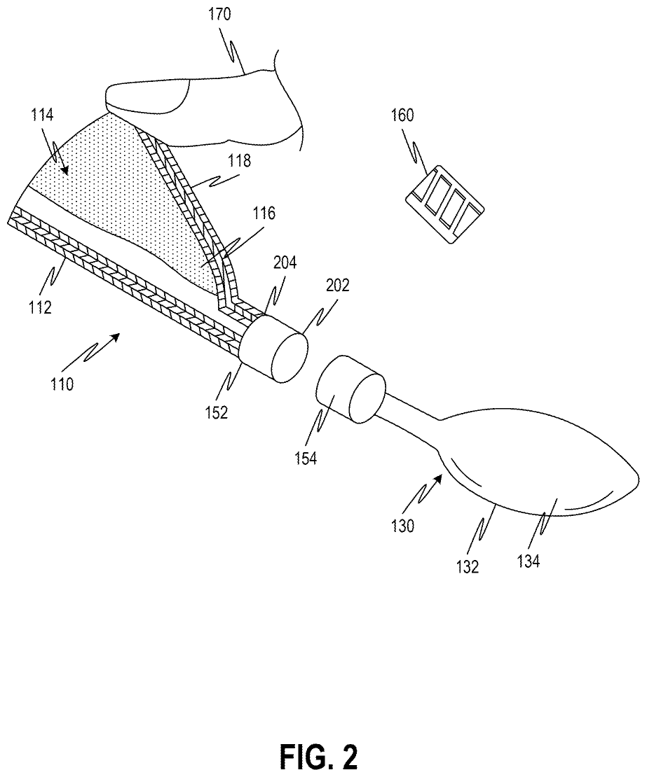

Referring now to FIGS. 1 and 2, illustrations are shown depicting the main components of a feeding apparatus 100 for implementing some embodiments of the present invention. The feeding apparatus 100 includes a food container 110 and a feeding device 130. The food container 110 and the feeding device 130 are removably attachable to each other by a connector 150. As described in additional detail below, during use, a person, for example using the person's hand or thumb 170, can compress the food container 110 and expel viscous food 116 onto a feeding surface 134 of the feeding device 130.

The food container 110 includes a food storage portion 112 that forms a cavity 114 and has an exterior surface 118. The cavity 114 of the food storage portion 112 is configured for containing the viscous food 116. The food container 110 further includes a food container end connector 152. The food container end connector 152 is arranged on an open end of the food storage portion 112 and can be understood to be one component of the connector 150.

The food storage portion 112 may be a food pouch, or other compressible container that forms the cavity 114, and allows compressive force to be applied such that viscous food 116, contained in the cavity 114, is expelled by the compressive force. In an example, the compressive force can be applied by a person, for example, by squeezing or pressing down on the exterior surface 118 of the food storage portion 112 with a hand or thumb 170.

In some preferred embodiments, the food container end connector 152 will be in fluid communication with one or more one-way valves 202, 204 (FIG. 2) that allow the viscous food 116 to flow out of the food storage portion 112 but prevents material (including contaminants) from entering into the food storage portion 112. Pressure from the person dispenses the viscous food 116 out of the food storage portion 112 via the food container end connector 152 and onto the feeding surface 134 of the feeding device 130. In this way, the food storage portion 112 in the food container 110 is in fluid communication with the feeding surface 134.

The feeding device 130 includes a feeding portion 132 and a feeding device end connector 154. The feeding portion 132 includes a feeding surface 134. The feeding device 130 is configured to be removably attachable to the food container 110 via the feeding device end connector 154. During use, the viscous food 116 expelled from the food container 110 passes through the feeding device end connector 154 (which may be wholly or in part overlapping with the food container end connector 152) and onto the feeding surface 134 of the feeding portion 132.

The connector 150 includes the food container end connector 152 and the feeding device end connector 154. The food container end connector 152 and the feeding device end connector 154 are configured to be easily attachable and detachable. The connector 150 will preferably be a quick connect device, such as a Luer lock connector, or almost any other fluidic quick disconnect apparatus.

Following a meal, the feeding device 130 may be disengaged (detached) from the food container 110 and a cap 160 may be attached to the food container end connector 152 to seal any viscous food remaining in the food storage portion 112. Subsequently, the feeding device 130 may be reconnected to the food container 110 for a next meal.

In some preferred embodiments, two (or more) one-way valves 202,204 may be positioned to trap viscous food 116 within the connector portion such that the trapped viscous food becomes a seal against any contaminants from entering the food storage portion 112 of the food container 110. The trapped viscous food 116 may then be expelled and discarded at the start of a next subsequent feeding session. In this manner, a more secure seal is made and maintained in between meals.

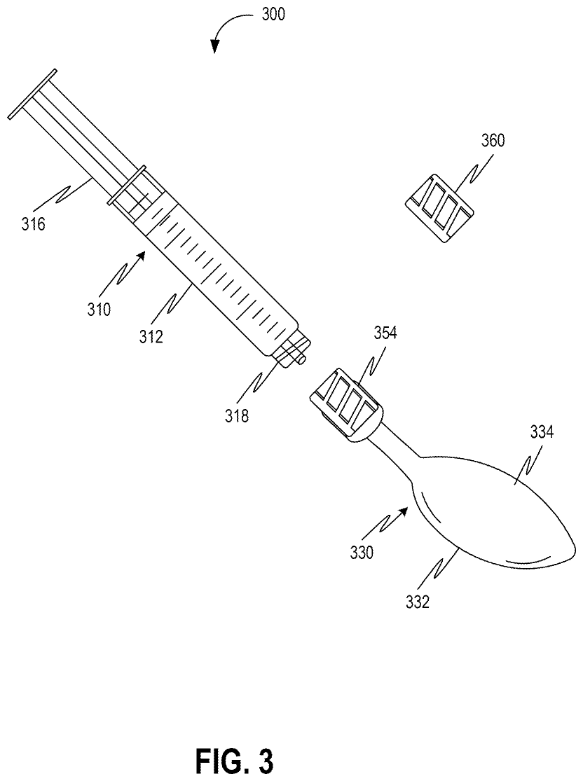

Referring now to FIG. 3, an alternative feeding apparatus 300 includes a food container 310 and a feeding device 330.

The food container 310 can be a syringe style container including a food storage portion 312 and a plunger 316. The food storage portion 312 forms an interior cavity 314. The plunger 316 is configured to respond to compressive force to move the plunger 316 into the food storage portion 312 and expel the viscous food 116 from the cavity 314. An end 318 of the food container 310 can be configured to be removably attachable to the feeding device 330 via a connector 354 on an end of the feeding device 330.

The feeding device 330 is like the feeding device 130 and includes a feeding portion 332 and a feeding device end connector 354. The feeding portion 332 includes a feeding surface 334. The feeding device end connector 354 is configured to be removably attachable to the end 318 of the food container 310.

During use, the viscous food 116 expelled from the food container 310 by application of force on the plunger 316 passes through the end 318 of the food container 310 and onto the feeding surface 334 of the feeding portion 332.

Preferably the syringe type food container 310 will include one or more one-way valves 202, 204 as described in reference to the food container 110, that prevent contaminants from entering the food storage portion 312. For example, the one or more one-way valves 202, 204 may be included in the end 318 of the food container 310.

After use, the feeding device 330 can be removed from the food container 310, and a cap 360 can be attached to the food container 310 to seal the food container 310 from outside contaminants.

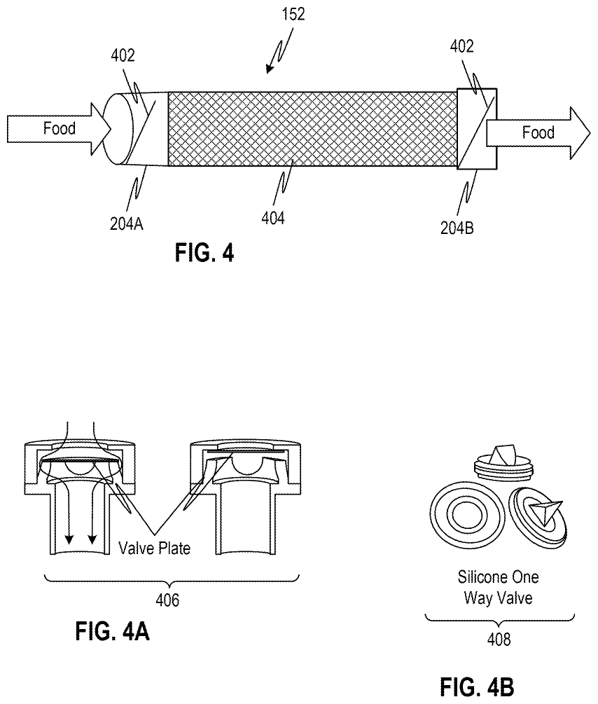

Referring now to FIG. 4, an exemplary viscous material sealing area 404 is incorporated into a connector such as the food container end connector 152 operative to connect a food storage container (e.g., the food storage container 110 of FIG. 1) with a feeding device (e.g., the feeding device 130 of FIG. 1). The viscous material sealing area 404 will preferably include two or more one-way valves 202a, 204a to contain a fixed amount of the viscous food 116 in a viscous material sealing area 404 between the one-way valves 202a, 202b. The viscous food 116 contained in the viscous material sealing area 404 during storage can act as a barrier to contaminants from passing through the one-way valves 202a, 202b and entering into the food storage area (e.g., the food storage portion 112 in FIG. 1). The sealed viscous food 116 may be expelled prior to a next meal being dispensed from the compressible food storage container. As shown in FIG. 4, the one-way valves 202a, 204a may be realized with valve flap seals 402.

FIGS. 4A and 4B illustrate different valve types that may be in fluid communication with a food storage portion (item 112 in FIG. 1). FIG. 4A illustrates a plated one-way valve 406. FIG. 4B illustrates multiple types of silicon one-way valves 408 that may be included in various implementations of the present invention. A one-way valve is preferably operational to allow viscous food to exit a compressible food container when compressive pressure is applied to a connected compressible food storage container sufficient to generate an expelling (outward) force on the viscous food that exceeds a predetermined threshold force to traverse a one-way valve in fluid communication with the compressible food storage container. The expelling force opens the one-way valve, into an open position, and moves at least a portion of viscous food from within the compressible food storage container through the one-way valve and onto a feeding surface. As the expelling force is relieved, the one-way valve will close into a closed position.

With the one-way valve in a closed position, the one-way valve preferably hygienically seals the viscous food from a potentially contaminating ambient environment and simultaneously impedes the viscous food from escaping the compressible food storage container.

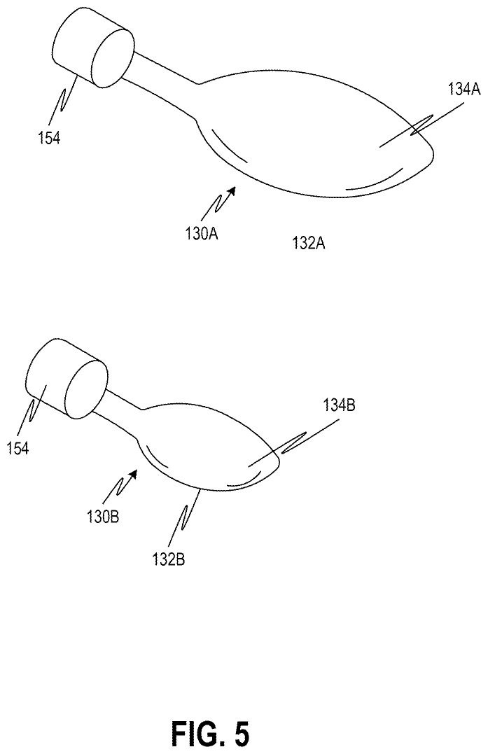

Referring now to FIG. 5, according to the present invention, a single source of viscous food 116 (e.g., the food container 110 of FIG. 1) may be attached to multiple different feeding devices. For example, the feeding devices 130 may be of different sizes, such as the feeding devices 130a and 130b.

The feeding device 130a includes a connector 154, a feeding portion 132a and feeding surface 134a, and may be large and configured for use by an adult. The feeding device 130b includes the connector 154, a feeding portion 132b and a feeding surface 134b, and may be smaller than the feeding device 130a and configured for use by an infant or small child. The feeding devices 130 may further include different shapes, types, and materials.

With feeding devices 130 of different sizes and shapes, persons of different sizes and needs may hygienically share a single source of food. For example, a child and an adult may attach disparate feeding devices 130 in a serial fashion to the food container 110 and each have a meal from the single source without exchanging germs, viruses or other contaminants.

In another aspect, a single person may use disparate feeding devices 130 at subsequent meals such that each meal may be had with a clean feeding device 130. For example, each feeding device 130 may be individually packaged and kept sterile (or at least very clean) up until a time of use. Following a meal, the feeding device 130 may be discarded or set aside for cleaning at a subsequent time and a new (clean) feeding device 130 may be used for a current meal.

As discussed above, preferred embodiments include a connector 150 including with two or more one-way valves 202, 204 configured to secure viscous food 116 in between the one-way valves 202, 204 and form a temporary seal. For example, the connector 150 may include a food container end connector 152 and the two or more one-way valves may be included in the food container end connector 152. The viscous food 116 forming the seal can be expelled and discarded prior to a subsequent feeding involving the food container 110 dispensing viscous food 116 onto the feeding surface 134.

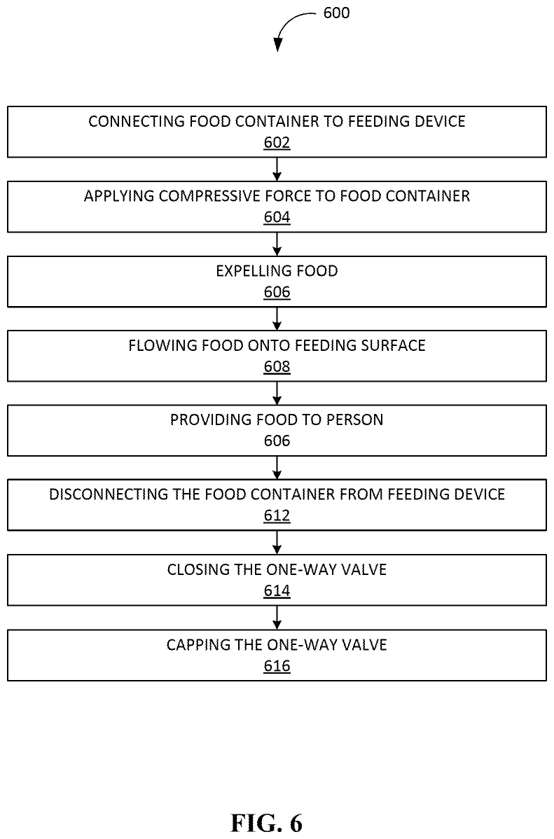

Referring now to FIG. 6, a flowchart illustrates an exemplary method 600 of feeding a person, according to some embodiments of the present disclosure. At step 602, the method 600 includes removably connecting a food container containing viscous food in a cavity of the food container to a feeding device comprising a feeding surface exterior to the food container. For example, the food container 110 containing the viscous food 116 in the cavity 114 can be removably connected to the feeding device 130.

At step 604, the method may include applying compressive force to an exterior surface of the food container, for example, the food container 110.

At step 606, the method 600 may include, responsive to the compressive force, expelling an amount of the viscous food from the cavity of the food container through a one-way valve through a connector. For example, the viscous food 116 can be expelled from the cavity 114 of the food container 110 through a one-way valve 204 included in that connector 150.

In some embodiments, at step 608, the method 600 may include flowing at least some of the expelled the viscous food onto feeding surface, for example the viscous food 116 onto the feeding surface 134.

At step 610, the method 600 may include providing the viscous food 116 on the feeding surface 134 to the person.

At step 612, the method 600 may include disconnecting the food container from the feeding device, for example, disconnecting the food container 110 from the feeding device 130.

At step 614, the method 600 may include closing the one-way valve thereby sealing the viscous food in the cavity of the food container from contaminants exterior to the food container. For example, the one-way valve 204 may seal the viscous food 116 in the cavity 114 of the food container 110.

At step 616, the method 600 may include capping the one-way valve and protecting the viscous food interior to the food container from contamination from an outside source. For example, the food container 110 may be capped with the cap 160, thereby protecting the viscous food 116 in the cavity 114 of the food container 110.

The method 600 is described above in reference to the feeding apparatus 100. This is only by way of example and not intended to be limiting. The method 600 can be similarly applied to other embodiments of the feeding apparatus.

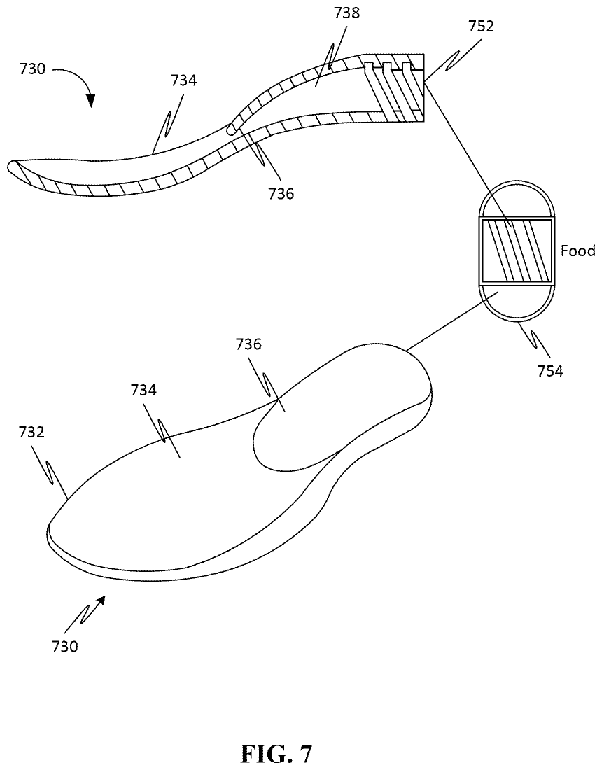

Referring now to FIG. 7, a cutaway view and a perspective view are provided of some embodiments of a feeding device 730 that include a reed valve 736 to control a flow of viscous food 116 from a food channel 738 onto a feeding surface 734 of a feeding device 732. The reed valve 736 is functional to be in a default closed state that prevents food from flowing without additional pressure applied to the flow of food, such as, by way of example, compressive pressure on a food container (not illustrated) attached to a connector 754. The feeding device 730 includes a feeding device end connector 752 that removably attaches to the connector 754. As pressure is applied to the viscous food 116 to flow through the reed valve 736, the reed valve 736 opens, and viscous food 116 is pushed onto the feeding surface 732. When pressure is released from the viscous food 116, the reed valve 736 closes.

Viscous food 116 may be consumed off of the feeding surface 732, such as via feeding a child or disabled person (or other consumer, including an animal). Additional viscous food 116 may be pushed through the reed valve 736 and onto the feeding surface 734 for additional feeding cycles. A cycle of pushing viscous food 116 through the reed valve 736, causing the reed valve 736 to open, ceasing to push the viscous food 116 thereby sealing the reed valve 736, removing viscous food 116 from the feeding surface 732, and pushing additional viscous food 116 through the reed valve 736 to repeat the cycle may be accomplished multiple times.

In the preceding sections, detailed descriptions of examples and methods of the disclosure have been described. The description of both preferred and alternative examples though thorough, are exemplary only, and it is understood that to those skilled in the art that variations, modifications, and alterations may be apparent. It is therefore to be understood that the examples do not limit the broadness of the aspects of the underlying disclosure as defined by the claims.

### CONCLUSION

A number of embodiments of the present disclosure have been described. While this specification contains many specific implementation details, they should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modifications, equivalents and alternatives falling within the spirit and scope of embodiments of the present disclosure as defined by the appended claims.

For example, the present invention may include an apparatus for feeding a person viscous food and methods of use of the apparatus. The apparatus may include a food container with a food storage portion, which may be a compressible food storage container, containing a viscous food and a first connector on an open end of the food storage portion. The food storage portion may be compressible; and a feeding device according to the present invention may include a feeding surface and a second connector removably attachable to the first connector.

Implementations may include one or more of the following features. The apparatus where the food container is configured such that, when the second connector is attached to the first connector, application of compressive pressure on the food storage portion expels the viscous food through the first connector and second connector onto the feeding surface of the feeding device. The food container is configured such that the compressive pressure can be applied by a person to an exterior surface of the food storage portion. The feeding device includes a feeding surface including a spoon shaped area. The first connector includes a one-way valve flow to impede flow of viscous food through the first connector. The one-way valve may include a silicon valve. The first connector includes two one-way valves. The two one-way valves form a sealing area in the first connector. The apparatus may include a cap removably attachable to the first connector, for closing the food container when disconnected from the feeding device. The food container may include a syringe and a food channel; and the food container may be configured such that, when a second connector is attached to the first connector, application of pressure on the food storage portion expels viscous food through the first connector and second connector through the food channel in the feeding device, and onto the feeding surface of the feeding device.

In some embodiments, a food channel may be in fluid communication with a one way valve, such as, for example a reed valve. Pressure applied to a compressible food storage portion, causes viscous food to apply sufficient pressure on the reed valve to open the reed valve and allow the viscous food to pass through the reed valve out onto the feeding surface. When pressure is released from the food storage portion, the reed valve closes. The apparatus may include: multiple interchangeable feeding devices.

One general aspect includes a method for feeding a person. The method includes removably connecting a food container containing viscous food to a feeding device; expelling an amount of the viscous food from the food container, where at least a portion of the amount of expelled viscous food flows onto a feeding surface of the feeding device; and providing the portion of the viscous food on the feeding surface of the feeding device to the person.

Implementations may include one or more of the following features. The method may include: applying compressive force to an exterior surface of a food storage portion of the food container, where the expelling of the amount of the viscous food contained in the food container is in response to the compressive force. A connector on an end of the food container connected to the feeding device includes a one-way valve and the amount of the viscous food is expelled through the one-way valve. The method may include: disconnecting the food container containing the viscous food from the feeding device and/or closing the one-way valve following disconnecting the food container from the feeding device.

In some embodiments, the method may include: removably attaching a cap to the connector on the end of the food container after closing the one-way valve. At least a portion of the second amount of expelled viscous food may flow onto the feeding surface of the feeding device.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C” “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. An apparatus for feeding a person viscous food, comprising:
a food container including a food storage portion containing a viscous food and a first connector on an open end of the food storage portion, the food storage portion being compressible; and
a feeding device including a feeding surface and a second connector removably attachable to the first connector.

2. The apparatus of claim 1, wherein the food container is configured such that, when the second connector is attached to the first connector, application of compressive pressure on the food storage portion expels the viscous food through the first connector and the second connector onto the feeding surface of the feeding device.

3. The apparatus of claim 2, wherein the food container is configured such that the compressive pressure can be applied by a person to an exterior surface of the food storage portion.

4. The apparatus of claim 1, wherein the feeding device includes the feeding surface including a spoon shaped area.

5. The apparatus of claim 1, wherein the first connector includes a one-way valve to impede flow of the viscous food through the first connector.

6. The apparatus of claim 5, wherein the one-way valve comprises a silicon valve.

7. The apparatus of claim 1, wherein the first connector includes two one-way valves.

8. The apparatus of claim 7, wherein the two one-way valves form a sealing area in the first connector.

9. The apparatus of claim 1, further comprising a cap removably attachable to the first connector, for closing the food container when disconnected from the feeding device.

10. The apparatus of claim 1, wherein the food container is a syringe.

11. The apparatus of claim 1, wherein:
the feeding device includes a food channel; and
the food container is configured such that, when the second connector is attached to the first connector, application of pressure on the food storage portion expels the viscous food through the first connector and the second connector, further through the food channel in the feeding device, and onto the feeding surface of the feeding device.

12. The apparatus of claim 11, wherein:
the food channel includes a reed valve, such that, (1) when pressure is applied to the food storage portion, the reed valve opens and allows the viscous food to pass through the reed valve to the feeding surface, and (2) when pressure is released from the food storage portion, the reed valve closes.

13. The apparatus of claim 1, further comprising:
multiple interchangeable feeding devices.

14. A method for feeding a person comprising:
removably connecting a food container containing viscous food to a feeding device;
expelling an amount of the viscous food from the food container, wherein at least a portion of the amount of the expelled viscous food flows onto a feeding surface of the feeding device; and
providing the portion of the viscous food on the feeding surface of the feeding device to the person.

15. The method of claim 14, further comprising:
applying compressive force to an exterior surface of a food storage portion of the food container, wherein the expelling of the amount of the viscous food contained in the food container is in response to the compressive force.

16. The method of claim 14, Wherein, a connector on an end of the food container connected to the feeding device includes a one-way valve and the amount of the viscous food is expelled through the one-way valve.

17. The method of claim 16, further comprising:
disconnecting the food container containing the viscous food from the feeding device.

18. The method of claim 17, further comprising:
closing the one-way valve following disconnecting the food container from the feeding device.

19. The method of claim 18, further comprising:
removably attaching a cap to the connector on the end of the food container after closing the one-way valve.

20. The method of claim 19, further comprising:
removing the cap from the connector on the food container;
expelling a remaining viscous food contained in the connector of the food container;
reconnecting the feeding device;
expelling a second amount of the viscous food from the food container, wherein at least a portion of the second amount of the expelled viscous food flows onto the feeding surface of the feeding device; and
providing the portion of the viscous food on the feeding surface of the feeding device to the person.
